(19) United States
(12) Patent Application Publication
(10) Pub. No.: US 2017/0280344 A1
(43) Pub. Date: Sep. 28, 2017

(54) CONTROL OF D2D MEASUREMENTS

(71) Applicant: Telefonaktiebolaget LM Ericsson (publ), Stockholm (SE)

(72) Inventor: Iana Siomina, Täby (SE)

(21) Appl. No.: 15/503,656

(22) PCT Filed: Sep. 24, 2014
(86) PCT No.: PCT/SE2014/051098

§ 371 Date: Feb. 13, 2017

(51) Int. Cl. H04W 24/10; H04L 12/24

(52) U.S. Cl. CPC H04W 24/10; H04L 41/0803; H04W 92/18

(57) ABSTRACT

There is disclosed a method for operating a mobile communication network, the method comprising determining a measurement performance characteristic for a D2D device in communication with the network and configuring the D2D device for D2D measurement with the measurement performance characteristic. There are also disclosed further related methods and devices.

### TECHNICAL FIELD

The present disclosure pertains to measurements in the context of D2D communication of D2D devices.

### BACKGROUND

For improved use of frequency bands and spectra reserved and/or licensed for mobile communication networks, e.g. according to LTE, there may be provided device-to-device (D2D) or ProSe (Proximity Services) functionality (the terms may be used interchangeably). Such functionality may allow D2D devices to communicate with each other using such bands or spectra, without the communication being relayed via a core network of the mobile communication network. Such a core network may be connecting different radio access networks providing wireless access. D2D communication may be performed in parallel or in alternative to cellular communication provided by the mobile communication network. However, the mobile communication network, in particular the radio access network, may providing auxiliary and/or managing functionality for D2D communication.

To facilitate D2D communication, either with radio access network support or without, D2D related measurements may be performed.

Performing D2D related measurements, or D2D measurements, requires resources on a D2D device. Depending on the operating conditions, resources may be insufficient for all desired measurements, in particular if a D2D device is participating in D2D communication and cellular communication at the same time. There are needed approaches to improve D2D measurements for a plurality of different conditions.

### SUMMARY

It is one object of the present disclosure to provide flexible approaches for D2D measurements, which can easily be adapted to different operating conditions.

In particular, in or in connection with D2D operation of a D2D device, the same level of D2D measurement performance or quality may be not needed in all scenarios. Also, there may be a trade-off between cellular and D2D measurement performance or quality of the same and/or different UEs, in particular with limited resources and capabilities. Moreover, a target measurement performance quality for D2D measurements may change dynamically, e.g., the performance or quality requirement may be increased in an emergency situation.

In some cases, a network, in particular a controlling node of a network, e.g. an eNodeB, may be not aware of the measurement performance or quality needed for a ProSe application for a given D2D device like a UE.

This object is achieved by the methods, devices and arrangements described herein.

According to one aspect, there is disclosed a method for operating a mobile communication network. The method comprises determining a measurement performance characteristic for a D2D device in communication with the network and configuring the D2D device for D2D measurement with the measurement performance characteristic.

Moreover, there is disclosed a method for operating a D2D device according to a further aspect. The method comprises obtaining a measurement performance characteristic and performing D2D measurement according to the measurement performance characteristic.

In addition, there is provided a method for operating a controlling node of a mobile communication network according to still another aspect. The method comprises obtaining, by the controlling node, a measurement performance characteristic for a D2D device in D2D communication with the network and configuring, by the controlling node, the D2D device for D2D measurement with the measurement performance characteristic.

There is further disclosed, according to another aspect, a method for operating a first D2D device. The method comprises obtaining, by the first D2D device, a measurement performance characteristic for a second D2D device connected or connectable for D2D communication with the first D2D device, and configuring, by the first D2D device, the second D2D device for D2D measurement with the measurement performance characteristic.

According to yet another aspect, there is described a mobile communication network. The network is adapted for determining a measurement performance characteristic for a D2D device connected or connectable for communication with the network and is further adapted for configuring the D2D device for D2D measurement with the measurement performance characteristic.

There is also disclosed, according to yet another aspect, a D2D device for mobile communication. The D2 device is adapted for obtaining a measurement performance characteristic and further is adapted for performing D2D measurement according to the measurement performance characteristic.

Moreover, according to a further aspect, there is disclosed a controlling node for a mobile communication network. The controlling node is adapted for obtaining a measurement performance characteristic for a D2D device connected or connectable for D2D communication with the network and is further adapted for configuring the D2D device for D2D measurement with the measurement performance characteristic.

A D2D device adapted for D2D communication according to another aspect is described. The D2D device is adapted for obtaining a measurement performance characteristic for a second D2D device connected or connectable for D2D communication with the D2D device and is further adapted for configuring the second D2D device for D2D measurement with the measurement performance characteristic.

According to a further aspect, there is provided a program product comprising code executable by control circuitry, the code causing the control circuitry to perform and/or control any one of the methods described herein.

Moreover, there is described, according to another aspect, a carrier medium carrying any one of the program products described herein and/or code executable by control circuitry, the code causing the control circuitry to perform and/or control any one of the methods as described herein.

With the methods and devices described herein, D2D measurements performed by a D2D device may be controlled with great flexibility according to requirements of different situations or operational conditions.

Generally, the D2D device, e.g. a user equipment (UE), may obtain a measurement performance characteristic, e.g. a priority and/or target quality, for its D2D measurements, which it may use for performing the measurements and/or based on which it may perform and/or be adapted to perform D2D measurements. The D2D device or UE may be adapted to meet one or more pre-defined requirements, which may be based on the measurement performance characteristic, e.g. priority and/or target quality.

A network node, e.g. a controlling node, or another (or second) D2D device, e.g. a UE, may be adapted for obtaining and/or obtain a measurement performance characteristic, e.g. priority and/or target quality, for D2D measurements of a first D2D device or UE, and may be adapted for signaling and/or signal, e.g. via transmitting, this information to another node, e.g. a network node or the first D2D device, and/or may be adapted for configuring and/or configure the first D2D device or UE for performing D2D measurements with and/or based on the measurement performance characteristic, e.g. priority and/or target quality.

The measurement performance characteristic, e.g. priority and/or target quality, may be determined and/or obtained such that may also control the trade-off between the performance and the resources used for D2D measurements and cellular operation.

The aspects and approaches described can provide flexible control of measurement performance characteristics, e.g. priority and quality, in particular for different scenarios with different D2D operations or operational conditions and/or with D2D and cellular operations. They also allow configuring different D2D measurement quality levels and/or requirements.

### BRIEF DESCRIPTION OF THE DRAWINGS

Some aspects of methods and arrangements for D2D communication or measurements are discussed with reference to the enclosed exemplary drawings. In the drawings, there are shown in:

FIG. 1 an arrangement of a D2D “direct mode”;

FIG. 2 an arrangement of a D2D “locally-routed” mode;

FIG. 3 an arrangement of cellular communication;

FIG. 4 a reference architecture for D2D operation;

FIG. 5 an example D2D device;

FIG. 6 an example eNodeB;

FIG. 7 a method for D2D measurement control;

FIG. 8 a network adapted to perform the method of FIG. 7;

FIG. 9a/b methods performed by a D2D device;

FIG. 10a/b example D2D devices

FIG. 11 a method performed by a controlling node

FIG. 12 an example controlling node.

### DETAILED DESCRIPTION

There is described a method for operating a mobile or wireless communication network. The method comprises determining a measurement performance characteristic for a D2D device in communication with the network and configuring the D2D device for D2D measurement with and/or based on the measurement performance characteristic.

The method may further comprise receiving, from the D2D device, D2D measurement reporting based on the measurement performance characteristic. The receiving may be performed by the network and/or a node of the network, in particular a controlling node, and/or receiving circuitry of a node or the network, which may be implemented as radio circuitry and/or control circuitry. The method may comprise operating based on the received reporting, in particular configuring, e.g. by the network and/or a controlling node of the network, a or the D2D device based on the received D2D measurement reporting, and/or scheduling, e.g. by the network and/or a controlling node of the network, communication resources, in particular for the D2D device, based on the received D2D measurement reporting.

Alternatively or additionally, the method may further comprise configuring the D2D device based on the received D2D measurement reporting.

Generally, there may be considered a mobile communication network adapted to perform any one of the methods for operating a mobile communication network described herein.

Further, there is disclosed a method for operating a D2D device. The method comprises obtaining a measurement performance characteristic. The method further comprises performing D2D measurement according to the measurement performance characteristic. This allows a flexible measurements according to different requirements or situations. The method optionally may comprise transmitting, by the D2D device, measurement reporting, e.g. to the network and/or to a second D2D device.

It may be considered that the method further comprises adapting a D2D measurement configuration of the D2D device based on the obtained measurement performance characteristic. Optionally, performing D2D measurement may be based on the D2D measurement configuration in this context.

According to one variant, obtaining a measurement performance characteristic may comprise receiving a measurement performance characteristic from a network, in particular a cellular network and/or a controlling node. Determining the characteristic may be performed centralized and/or based on information regarding additional D2D devices or UEs or network nodes and/or respective operational conditions. Alternatively or additionally, obtaining a measurement performance characteristic may generally comprise receiving at least one measurement performance characteristic from another D2D device. In particular, the another or second D2D device may directly provide, e.g. transmit, the measurement performance characteristic, without involving the network.

Furthermore, there is disclosed a method for operating a controlling node of a mobile communication network. This method comprises obtaining, by the controlling node, a measurement performance characteristic for a D2D device in D2D communication with the network. This method further comprises configuring, by the controlling node, the D2D device for D2D measurement with and/or based on the measurement performance characteristic.

The method may further comprise receiving, by the controlling node, D2D measurement reporting based on the measurement performance characteristic from the D2D device. The method may comprise operating based on the measurement reporting, in particular configuring, e.g. by the controlling node, a or the D2D device based on the received D2D measurement reporting, and/or scheduling, e.g. by the controlling node, communication resources, in particular for a or the D2D device, based on the received D2D measurement reporting.

In addition, there is disclosed of method for operating a first D2D device. The method comprises obtaining, by the first D2D device, a measurement performance characteristic for a second D2D device connected or connectable to the first D2D device for D2D communication. The method further comprises configuring, by the first D2D device, the second D2D device for D2D measurement with the measurement performance characteristic.

The method may further comprise receiving, by the first D2D device, D2D measurement reporting based on the measurement performance characteristic from the second D2D device. The method may comprise operating based on the measurement reporting, in particular configuring, e.g. by the first D2D device, the first and/or second D2D device based on the received D2D measurement reporting and/or scheduling, e.g. by the first D2D device, communication resources, in particular for the first and/or second D2D device, based on the received D2D measurement reporting.

There is also described a mobile communication network. The network is adapted for, and/or may comprise control circuitry for and/or a determining module for, determining a measurement performance characteristic for a D2D device connected or connectable for communication with the network. The network is further adapted for, and/or may comprise control circuitry for and/or a configuration module, for configuring the D2D device for D2D measurement with the measurement performance characteristic.

The circuitry and/or modules of the network generally may be arranged on the same node or, alternatively, be distributed over several nodes and/or within the network.

The network may further be adapted for, and/or may comprise radio circuitry and/or control circuitry for and/or a receiving module for, receiving, from the D2D device, D2D measurement reporting based on the measurement performance characteristic.

It may be considered that the network is adapted for, and/or comprises control circuitry for and/or a operating module and/or configuring module and/or scheduling module for, operating based on the received measurement reporting, in particular configuring the D2D device based on the received D2D measurement reporting and/or for scheduling communication resources, in particular for the D2D device, based on the received D2D measurement reporting.

Moreover, there is disclosed a D2D device adapted for D2D communication. The D2D device is adapted for, and/or may comprise control circuitry and/or radio circuitry for and/or an obtaining module for, obtaining a measurement performance characteristic. The D2D further is adapted for, and/or may comprise control circuitry and/or radio circuitry and/or measurement circuitry for and/or a measuring module for, performing D2D measurement according to and/or based on the measurement performance characteristic.

The D2D device may further be adapted for, and/or may comprise control circuitry for and/or a adapting module for, adapting a D2D measurement configuration of the D2D device based on the obtained measurement performance characteristic. Optionally, the D2D device may additionally or alternatively be adapted for, and/or comprise control circuitry for and/or the measurement module adapted for, performing the D2D measurement based on the D2D measurement configuration.

Generally, obtaining a measurement performance characteristic may comprise receiving a measurement performance characteristic from a network, in particular a cellular network and/or a controlling node. Alternatively or additionally, obtaining a measurement performance characteristic may comprise receiving at least one measurement performance characteristic from another D2D device. Control circuitry and/or radio circuitry and/or a receiving module may be provided for such receiving.

There is also described a controlling node for a mobile communication network. The controlling node is adapted for, and/or may comprise control circuitry and/or radio circuitry for and/or an obtaining module for, obtaining a measurement performance characteristic for a D2D device connected or connectable for D2D communication with the network. The controlling node is further adapted for, and/or may comprise control circuitry for and/or a configuring module for, configuring the D2D device for D2D measurement with the measurement performance characteristic.

The controlling node may further be adapted for, and/or may comprise control circuitry and/or radio circuitry for and/or a receiving module for, receiving D2D measurement reporting based on the measurement performance characteristic from the D2D device. It may be considered that the controlling node is adapted for, and/or may comprise control circuitry for and/or an operating module and/or a configuring module and/or scheduling module for, operating based on the received measurement reporting, in particular configuring a or the D2D device based on the received D2D measurement reporting and/or for scheduling communication resources, in particular for the D2D device, based on the received D2D measurement reporting.

There is further disclosed a D2D device adapted for D2D communication. The D2D device is adapted for, and/or may comprise control circuitry and/or radio circuitry for and/or an obtaining module for, obtaining a measurement performance characteristic for a second D2D device connected or connectable for D2D communication with the D2D device. The D2D device is further adapted for, and/or may comprise control circuitry and/or radio circuitry for and/or a configuring module for, configuring the second D2D device for D2D measurement with the measurement performance characteristic.

The D2D device may further be adapted for, and/or may comprise control circuitry and/or radio circuitry for and/or a receiving module for, receiving D2D measurement reporting based on the measurement performance characteristic from the second D2D device. Optionally, the D2D device may be adapted for, and/or may comprise control circuitry and/or radio circuitry for and/or an operating module and/or a configuring module and/or a scheduling module for, operating based on the received measurement reporting, in particular configuring the second D2D device and/or itself based on the received D2D measurement reporting and/or for scheduling communication resources, in particular for and/or in regards to the second D2D device and/or itself, based on the received D2D measurement reporting.

Also, there is disclosed a program product comprising code executable by control circuitry, the code causing the control circuitry to perform and/or control at least any one of the methods described herein.

Moreover, there may be considered a carrier medium carrying and/or storing at least any of the program products described herein and/or code executable by control circuitry, the code causing the control circuitry to perform and/or control at least any one of the methods described herein. Generally, a carrier medium may be accessible and/or readable and/or receivable by control circuitry. Storing data and/or a program product and/or code may be seen as part of carrying data and/or a program product and/or code. A carrier medium generally may comprise a guiding/transporting medium and/or a storage medium. A guiding/transporting medium may be adapted to carry and/or carry and/or store signals, in particular electromagnetic signals and/or electrical signals and/or magnetic signals and/or optical signals. A carrier medium, in particular a guiding/transporting medium, may be adapted to guide such signals to carry them. A carrier medium, in particular a guiding/transporting medium, may comprise the electromagnetic field, e.g. radio waves or microwaves, and/or optically transmissive material, e.g. glass fiber, and/or cable. A storage medium may comprise at least one of a memory, which may be volatile or non-volatile, a buffer, a cache, an optical disc, magnetic memory, flash memory, etc.

Generally, there may be considered a D2D device adapted to perform any one of the methods for operating a D2D device described herein.

Additionally or alternatively, there may generally be considered a controlling node adapted to perform any one of the methods for operating a controlling node described herein.

A controlling node may generally be implemented as base station or eNodeB.

A mobile communication network may generally comprise one or more than one network nodes, in particular a controlling node as described herein, and/or a radio access network (which may comprise the one or more than one network nodes) and/or a core network connected or connectable to the radio access network. The network and/or controlling node may be adapted to provide one or more cells for wireless and/or radio communication and/or to serve one or more D2D devices or UEs. A mobile communication network may be a cellular network. The controlling node may be adapted for controlling and/or serving and/or provide and/or support cellular communication and/or D2D communication.

Determining and/or obtaining and/or receiving a measurement performance characteristic may generally comprise determining and/or obtaining and/or receiving one or more than one measurement performance characteristics.

Configuring a D2D device may involve instructing and/or causing the D2D device to change its configuration, e.g. at least one setting and/or register entry and/or operational mode. Configuring a D2D device for D2D measurement may refer to instructing and/or causing the D2D device to change operational parameters for D2D measurement, in particular according to a measurement performance characteristic. A D2D device may be adapted to configure itself. Configuring a D2D device by another device or node or network may refer to transmitting information and/or data and/or instructions to the D2D device by the other device or node or network, e.g. at least one measurement performance characteristic, based on which the D2D device may configure and/or reconfigure, e.g. a D2D configuration, which may involve changing one or more parameters and/or settings.

Adapting a configuration may refer to configuring the D2D device, in particular by changing the configuration, e.g. by the D2D device.

Obtaining a measurement performance characteristic may comprise receiving, e.g. from another node and/or device and/or the network, the measurement performance characteristic and/or determining the measurement performance characteristic.

Determining the measurement performance characteristic may comprise calculating and/or estimating the measurement performance characteristic, e.g. based on operational parameters or conditions of the D2D device and/or network and/or other D2D devices and/or resource use. Determining may in particular be based on whether the D2D device is involved in D2D communication or cellular communication or both.

A measurement performance characteristic may generally refer to at least one parameter or indicator relevant for D2D measurements and/or involved or present in a D2D measurement configuration of a D2D device. A measurement performance characteristic may e.g. comprise at least one timer and/or repetition factor and/or requirement, e.g. a minimum resolution or quality or number of measurement points for a D2D measurement. The measurement performance characteristic may be general and/or pertain to at least one communication resource, in particular a frequency-related resource and/or a time-related resource, e.g. a frequency and/or bandwidth and/or spectrum and/or carrier and/or carrier aggregate. Generally, a measurement performance characteristic may refer to a priority and/or target measurement quality. A target measurement quality may refer to a characteristic or performance or requirement for or of the D2D measurement. The measurement performance characteristic may generally refer and/or pertain to D2D measurements performed and/or to be performed by a D2D device, in particular during and/or for and/or pertaining to D2D operation by this D2D device.

A D2D device may be considered to be connected or connectable for communication if it is able to communicate with another node or device or a network via wireless communication, in particular via D2D communication and/or cellular communication, e.g. if it is registered or may be registered in the network or with another D2D device, and/or is in such communication.

Receiving or transmitting, e.g. in the context of configuring the D2D device, may generally be performed via cellular communication and/or D2D communication.

Measurement reporting may refer to a D2D device transmitting measurement results and/or measurement data and/or measurement parameters and/or measurement performance characteristics and/or results of evaluation of measurement data, e.g. to a receiving node or network or a D2D device. The measurement and/or evaluation may be based on the measurement performance characteristic, e.g. due to the measurements being performed based on the measurement performance characteristic and/or the D2D configuration having been adapted based on the measurement performance characteristic. Evaluation may include performing calculations based on measurement results or values, e.g. averaging.

A D2D measurement configuration may refer to the settings and/or configuration used by a D2D device for D2D measurement. Different kinds of measurement may have different configurations assigned or associated to them.

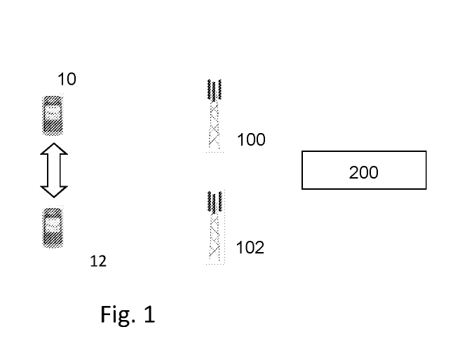

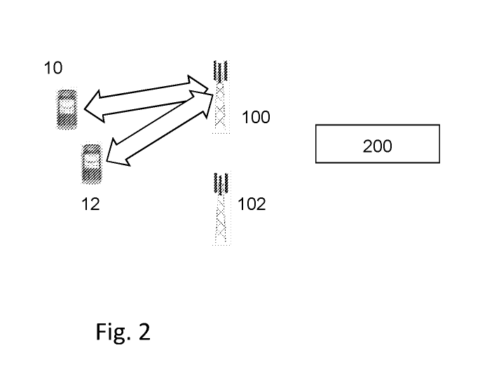

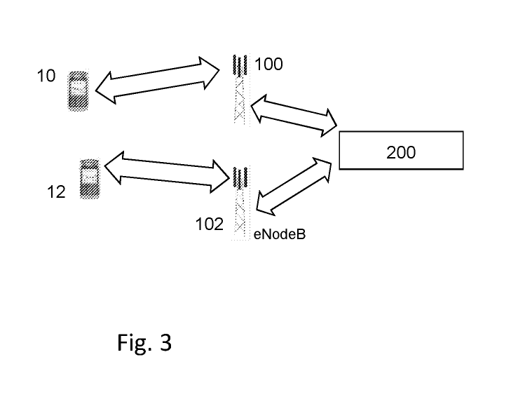

If D2D devices or UEs are in proximity to each other, they may be able to use a “direct mode” (e.g., as in FIG. 1) or “locally-routed” (e.g., as in FIG. 2) path for data communication, unlike in the conventional cellular communication (FIG. 3). In such device-to-device communication (D2D), which may also be called “ProSe” (for PROximity SErvices), the source and the target are wireless devices like D2D devices, e.g., UEs. Some of the potential advantages of D2D or ProSe are off-loading of the cellular network, faster communication, increased awareness of surrounding wireless devices of interest (e.g., running the same application), higher-quality links due to a shorter distance, etc. Some appealing applications of D2D communications are video streaming, online gaming, media downloading, peer-to-peer (P2P), file sharing, etc.

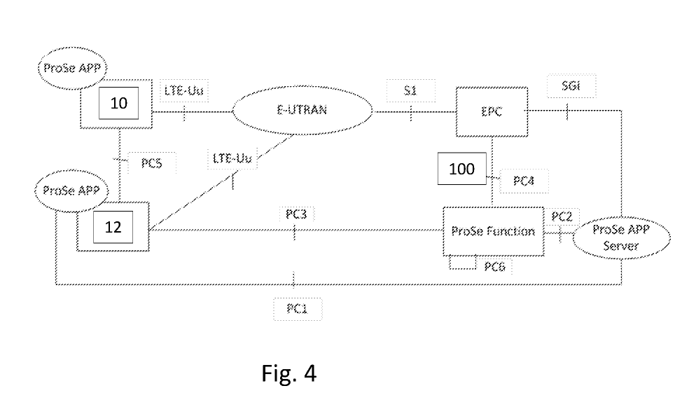

A more detailed example reference architecture for D2D operation is illustrated in FIG. 4.

There are shown:

FIG. 1: “Direct mode” data path in the EPS for communication between two UEs [TR 22.803].

FIG. 2: “Locally-routed” data path in the EPS for communication between two UEs when UEs are served by the same eNBs [TR 22.803].

FIG. 3: Default data path scenario in the EPS for cellular communication between two UEs [TR 22.803].

FIG. 4. An example D2D architecture.

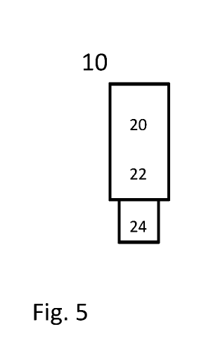

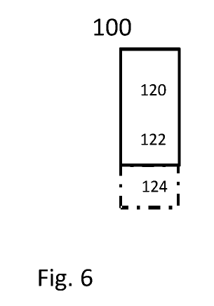

FIGS. 5 and 6: Structures of a UE and an eNB as examples for a D2D device and a base station or network node, respectively.

Generally, a UE may be considered as an example or representative of a D2D device, and the term D2D device may be interchanged for UE unless explicitly stated otherwise.

An eNodeB or eNB or base station may be considered to be one variant of a network node, in particular a controlling node.

In FIGS. 1 to 3, there are shown different setups for communication of user equipments (as examples for D2D devices) within a mobile communication network. In these figures, the first node or first user equipment UE1 is indicated with reference numeral 10, the second node or second user equipment is indicated with reference numeral 12. A first base station or network node, which may be an eNodeB and/or EPC according to LTE/E-UTRAN, carries the reference numeral 100, whereas a second base station, which may be an eNodeB and/or EPC according to LTE/UTRAN, is referenced with numeral 102. The nodes 100, 102 may be configured as coordinating nodes for D2D communication between the UEs 10, 12. Reference numeral 200 indicates higher layer functions or devices of the network, to which the base stations 100, 102 may be connected or connectable, e.g. LTE packet core elements like SGW (Server GateWay) and/or PGW (PDN GateWay) and/or MME (Mobility Management Entity).

If UEs 100, 102 are in proximity to each other, they may be able to use a “direct mode” (e.g., as in FIG. 1) or “locally-routed” (e.g., as in FIG. 2) path for data communication, unlike in the conventional cellular communication (FIG. 3).

A more detailed example reference architecture for D2D operation according to one possible LTE/E-UTRAN implementation is illustrated in FIG. 4, in which only a setup with two UEs 10, 12 connected to a common base station or eNodeB 100 is shown. In FIG. 4, PCn identifies different reference points or interfaces. PC1 refers to a reference point between a ProSe application ProSe APP running on an D2D device or UE 10 or 12, PC2 a reference point between an ProSe Application server and a ProSe function provider on a server or base station side. PC3 indicates a reference point between the D2D device or UE 12 and the ProSE function, e.g. for discovery and/or communication. PC4 refers to a reference point between the EPC and the ProSe function, e.g. for setting up setting up one-to-one communication between UEs 10 and 12. PC5 is a reference point between D2D device or UE 10 and D2D device or UE 12, e.g. a first node and a second node involved in D2D communication, which may be used e.g. for direct or relayed communication between the UEs. PC6 identifies a reference point between ProSE functions of different networks, e.g. if UEs 10, 12 are subscribed to different PLMNs (Public Land Mobile Networks). SGi indicates an interface which may be used, inter alia, for application data and/or application level control. The EPC (Evolved Packet Core) may generally include a plurality of core packet functions or entities, e.g. MME, SGW, PWG, PCRF (Policy Charging and Rules Function), HSS (Home Subscriber Server), etc. E-UTRAN is the preferred RAT of the arrangement of FIG. 4. LTE-Uu indicates data transmission connections between the UEs 10, 12 and the base station 100.

FIG. 5 schematically shows a D2D device or user equipment 10, which may be a node of or for a device-to-device communication, in closer details. User equipment 10 comprises control circuitry 20, which may comprise a controller connected to a memory. A receiving module and/or transmission module and/or control module may be implemented in the control circuitry 20, in particular as module in the controller. The user equipment also comprises radio circuitry 22 providing receiving and transmitting or transceiving functionality, the radio circuitry 22 connected or connectable to the control circuitry. An antenna circuitry 24 of the user equipment 10 is connected or connectable to the radio circuitry 22 to collect or send and/or amplify signals. Radio circuitry 22 and the control circuitry 20 controlling it are configured for device-to-device communication, in particular utilizing E-UTRAN/LTE resources as described herein and/or receiving allocation data and/or transmit D2D data based on allocation data.

FIG. 6 schematically show a base station 100, which in particular may be an eNodeB. Base station 100 comprises control circuitry 120, which may comprise a controller connected to a memory. A configuring unit and/or a determination unit may be comprised in the control circuitry, the latter in particular if the base station is configured as a coordinating node. The control circuitry is connected to control radio circuitry 122 of the base station 100, which provides receiver and transmitter and/or transceiver functionality. It may be considered that control circuitry 120 comprises an extracting unit as described herein, in particular if the base station is configured to participate as a device in D2D communication. An antenna circuitry 124 may be connected or connectable to radio circuitry 122 to provide good signal reception or transmittance and/or amplification.

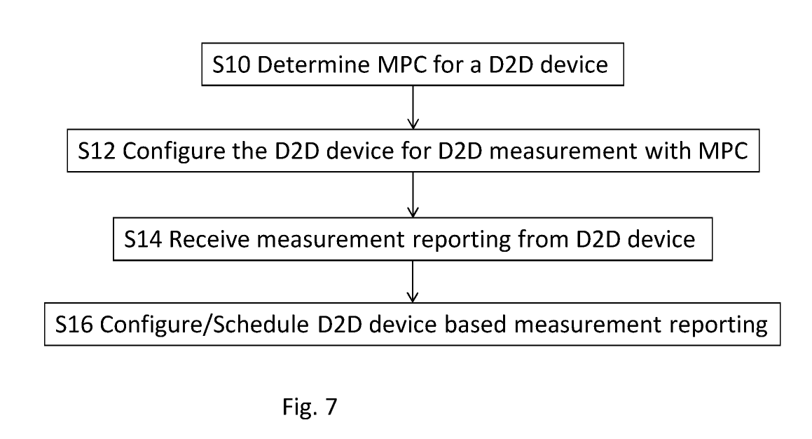

FIG. 7 shows a diagram for a method for operating a mobile communication network. The network may in an action S10 determine a measurement performance characteristic (MPC) for a D2D device in communication with the network. Generally, the communication may be via D2D operation/communication and/or cellular operation/communication. In an action S12, the network may configure the D2D device for D2D measurement with and/or based on the measurement performance characteristic. Optionally, in an action S14, the network may receive measurement reporting from the D2D device. In an optional action S16, the network may configure at least one D2D device and/or schedule resources for at least one D2D device, which may comprise the D2D device configured for D2D measurement in S12 or at least one different D2D device.

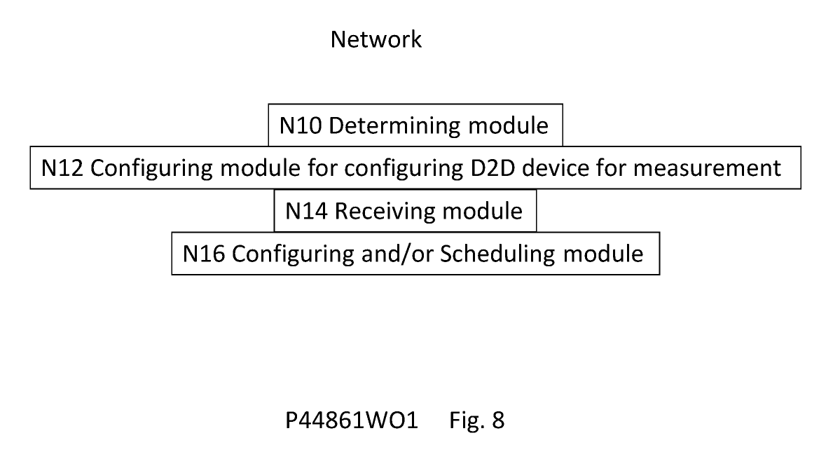

FIG. 8 shows a mobile communication network comprising determining module N10 for performing action S10 and a configuring module N12 for configuring a D2D device for measurement and/or for performing action S12. Optionally, the network may comprise a receiving module N14 for performing action S14 and/or a configuring module and/or scheduling module N16 for performing action S16.

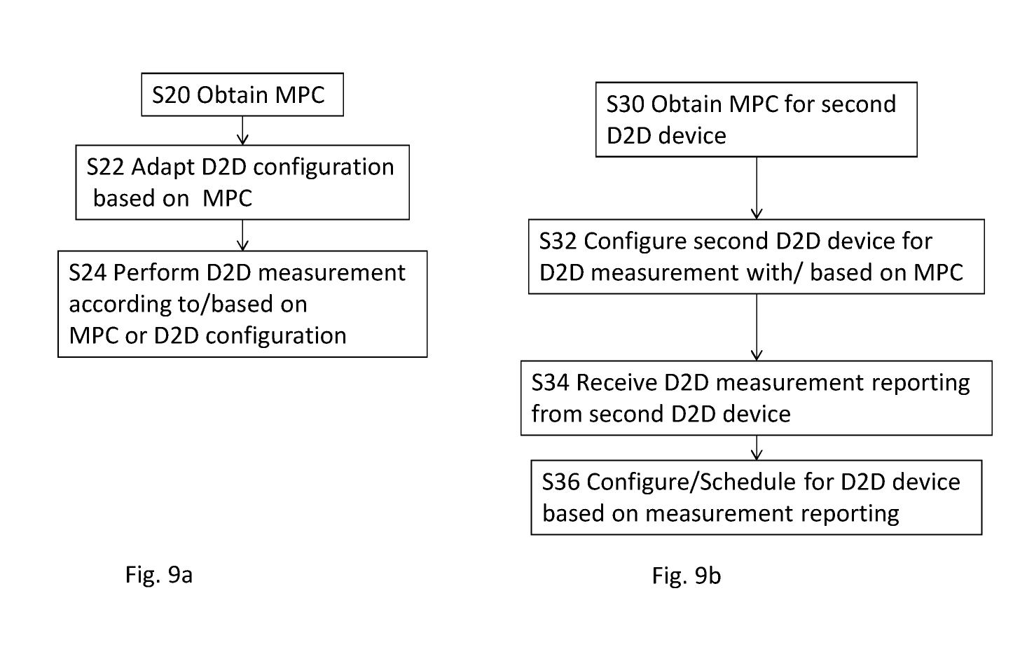

FIG. 9a shows a method for operating a D2D device. The D2D in action S20 may obtain a measurement performance characteristic, e.g. by receiving it from another D2D device or a node or network and/or determining it itself. In optional step S22, the D2D device may adapt its D2D configuration based on the obtained MPC. In action S24, the D2D device may perform D2D measurement according to and/or based on the measurement performance characteristic and/or the adapted D2D configuration.

FIG. 9b shows a further method for operating a D2D device, which may be a first D2D device. The D2D device in an action S30 may obtain a measurement performance characteristic for a second D2D device connected or connectable to the D2D device for D2D communication. In a step S32, the D2D device may configure the second D2D device for D2D measurement with and/or based on the measurement performance characteristic. In an optional action S34, the D2D device may receive measurement reporting from the second D2D device. In an optional action S36, the D2D device may configure at least one D2D device and/or schedule resources for at least one D2D device, which may comprise the D2D device and/or the second D2D device.

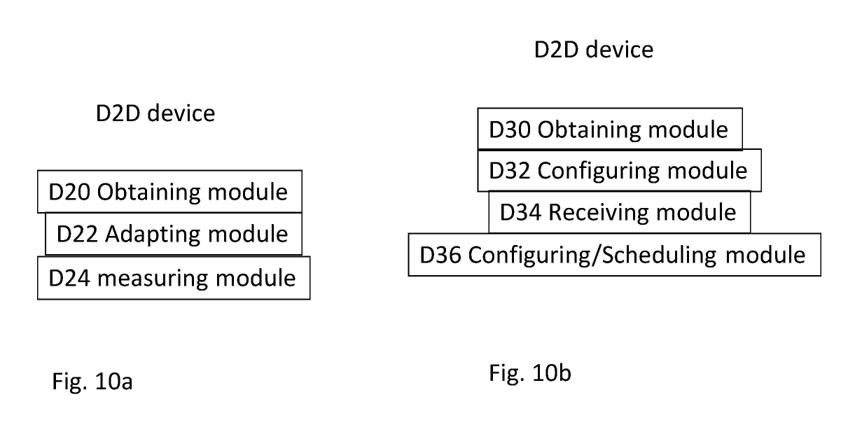

FIG. 10a shows a D2D device comprising an obtaining module D20 for performing action S20 and a measuring module D24 for performing action S24. Optionally, the D2D device may comprise an adapting module D22 for performing action S22.

FIG. 10b shows a D2D device comprising an obtaining module N30 for performing action S30 and a configuring module D32 for performing action S32. Optionally, the D2D device may comprise a receiving module D34 for performing action S34 and/or a configuring module and/or scheduling module D36 for performing action S36.

Generally, a D2D device may be adapted to perform the methods of 9a and/or 9b.

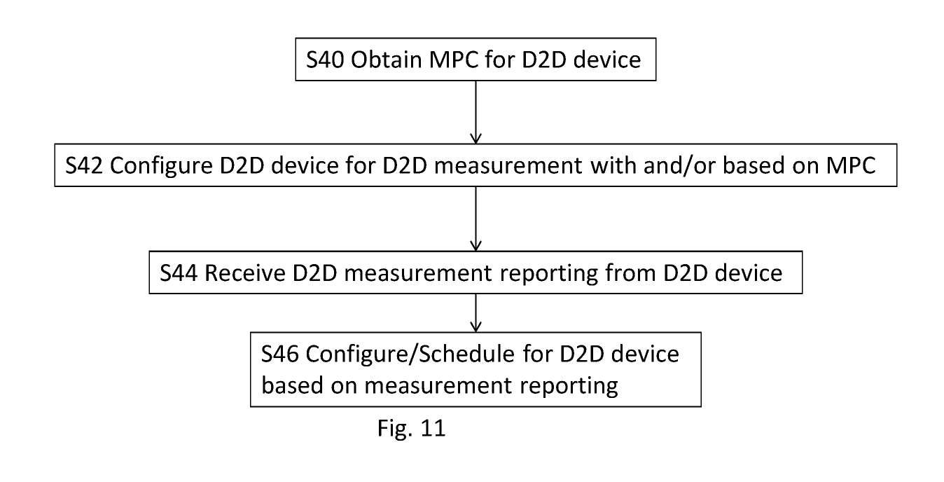

FIG. 11 shows a method for operating a controlling node of or for a mobile communication network. In an action S40, the controlling node may obtain a measurement performance characteristic for a D2D device in D2D communication with the network, in particular the controlling node. In action S42, the controlling node may configure the D2D device for D2D measurement with and/or based on the measurement performance characteristic. Optionally, in an action S44, the controlling node may receive measurement reporting from the D2D device. In an optional action S46, the controlling node may configure at least one D2D device and/or schedule resources for at least one D2D device, which may comprise the D2D device configured for D2D measurement in S42 or at least one different D2D device.

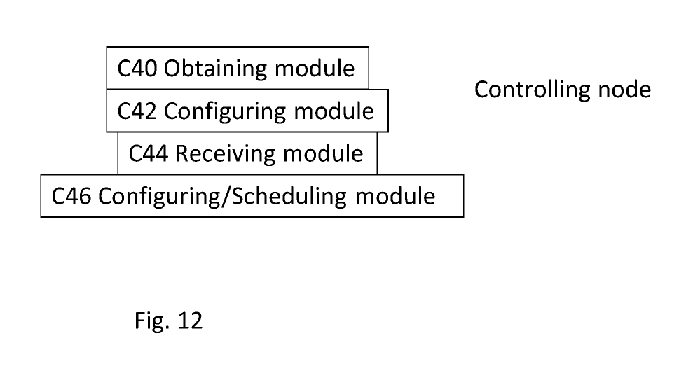

FIG. 12 shows a controlling node comprising an obtaining module C40 for performing action S40 and a configuring module C42 for performing action S42. Optionally, the controlling module may comprise a receiving module C44 for performing action S44 and/or a configuring/scheduling module C46 for performing action S46.

The controlling node may be implemented as base station or eNodeB.

Some non-limiting example scenarios in which the embodiments described in the current disclosure apply are described below. In the examples, a user equipment is referred to as example for a D2D device. In any of the examples, the term user equipment may be replaced by introducing the term D2D device instead.

Scenario 1: A UE is performing or configured to perform one or more D2D measurements during its D2D operation, regardless whether there are or there are no other types of UE operation (e.g., cellular operation).

The UE may be in any activity state with respect to a cellular network (e.g., RRC_IDLE or RRC_CONNECTED) or may be out of the network coverage.

Scenario 1a: The same UE is performing or configured to perform one or more D2D measurements during its D2D operation, while at the same time performing one or more cellular operations.

A D2D device may perform and/or be adapted to perform the steps of:

Step 1: Obtaining a measurement performance characteristic MPC, e,g. at least one of a D2D measurement priority and a D2D measurement target quality. The D2D device may comprise a corresponding obtaining module.
Step 2(optional): Adapting its D2D measurement configuration, based on the obtained MPC and/or at least one of the priority and target quality. The D2D device may comprise a corresponding adapting module.
Step 3: Performing at least one D2D measurement, with and/or based on the MPC and/or using the adapted configuration. The D2D device may comprise a corresponding measuring module.
Step 4 (Optional): Using the D2D measurement result for at least one operational task and/or operating based on the D2D measurement. The D2D device may comprise a corresponding operating module.

The D2D device may comprise control circuitry and/or radio circuitry adapted for carrying out or performing the steps or actions described.

Generally, for the measurement performance characteristic (MPC) there may hold:

The MPC and/or a D2D measurement priority may comprise any one or more of:

a priority indicator (e.g., ‘yes’/‘no’) or priority level (e.g., ‘high’/‘low’, a configurable priority level, a priority level from a pre-defined list), an absolute priority,
a relative priority, e.g. prioritising between D2D communication and cellular communication.

The priority may be with respect to another D2D measurement type, any other D2D measurement type, one or more specific cellular measurements or cellular operation in general.

Alternatively or additionally, the MPC and/or a D2D measurement target (desired) quality may comprise any one or more of the parameters:

a minimum, maximum, or average measurement characteristic or measurement configuration parameter value or measurement requirement;
a number of samples to be measured;
a measurement time, in particular a minimum and/or target measurement time;
a measurement reporting delay, in particular a minimum or maximum and/or target measurement reporting delay;
a measurement accuracy or target error, in particular a minimum accuracy or maximum target error;
a measurement uncertainty, in particular a maximum or target uncertainty;
a number of correct/reliable measurement events, in particular in particular a minimum and/or target number of correct/reliable measurement events;
a parameter which may be mapped/which is mappable to one or more of the above measurement quality parameters and/or from which a MPC and/or one of the mentioned parameters may be derived (e.g., desired D2D positioning accuracy may be mapped to a minimum number of measurements and/or maximum measurement error/uncertainty).

Generally, the MPC, in particular the priority and/or the target quality, may be associated with and/or pertain to specific communication resources, in particular specific time- and/or frequency resources (e.g., certain subframes and/or carrier frequency or frequency band), which may be pre-defined (e.g., a frequency band for Public Safety; subframe #0) or configurable (e.g., time-domain pattern indicating subframes where D2D measurements are prioritized or deprioritized with respect to cellular operation).

Generally, obtaining, e.g. the MPC and/or the priority and/or target quality, in particular obtaining by the D2D device, may comprise any one or more of:

autonomously deciding and/or determining, in particular by the D2D device;
using, in particular by the D2D device, a pre-defined or implicitly defined MPC and/or priority and/or target quality and/or corresponding configuration;
using, in particular by the D2D device, a pre-configured MPC or priority and/or (target measurement quality, e.g. based on data read from a database and/or subscription data, or a read from a SIM card,
deriving/deciding/selecting the MPC or priority and/or target measurement quality, in particular by the D2D device, based on a pre-defined rule or based on a condition, in particular an operation condition, which may e.g. refer to whether the D2D device perform D2D operation or cellular operation or both;
receiving, in particular by the D2D device, the MPC and/or priority and/or measurement quality from another D2D device or a UE or a network node (e.g., eNodeB or controlling node) or a network or a D2D server (logical or physical), in particular via broadcast/multicast/unicast, e.g. via a control channel, shared channel, or higher layers.

The obtaining may be prior to each measurement or upon a trigger, e.g., a triggering condition, a triggering event or a triggering signalling (broadcast/multicast/unicast) from another D2D device or UE or a network node, in particular a controlling node, or a network. The trigger may also be indicative of the requested or configured change or change direction (e.g., increase or decrease incrementally) in the MPC, in particular the priority and/or target quality setting, and/or an associated D2D measurement configuration.

The obtaining of the MPC and/or priority and/or target quality may further comprise their determining accounting for and/or based on and/or pertaining to and/or considering any one or more of:

Carrier frequency/frequency band type (e.g., Public Safety or Emergency); User demand or need (e.g., emergency or non-emergency);
Resource availability for D2D and/or cellular (e.g., scarce resources may need to be used more efficiently);
D2D measurement periodicity (with longer periodicity it is more crucial to utilize each measurement opportunity);
D2D measurement type (e.g., parameter to be measured and/or received signal strength or quality, timing measurement, etc.), D2D measurement purpose;
Number of D2D measurements (if the same measurement will be repeated shortly, the accuracy may be less crucial; multiple parallel measurements may be more challenging to perform with high quality);
Amount of processing efforts for one D2D measurement and/or resources required, in particular measurement and/or computing resources on the D2D device;
D2D service type using the D2D measurement (e.g., a commercial application which may be streaming or background [less crucial for background applications which are typically best-effort]; in which the service may be less important compared to an emergency service and/or have lower priority),
The D2D measurement criticality/importance,
power consumption of the D2D device or UE for performing one D2D measurement and/or the D2D measurements;
whether the MPC and/or priority and/or target quality for a first D2D device is determined by the first D2D device and/or received by the first D2D device, e.g. from another D2D device and/or from a network node like a controlling node, and/or from a network and/or D2D server;
estimated, predicted or measured interference level when performing the D2D measurement;
estimated or predicted quality of the D2D measurement (e.g., absolute or relative), e.g. regarding an interference level or signal-to-noise ratio;
D2D device, e.g. UE, activity state (e.g., idle or active; in DRX or non-DRX).

Performing measurements based on the obtained MPC and/or adapting the D2D measurement configuration of a D2D device or UE, based on the obtained MPC and/or priority and/or target quality, may be performed in particular corresponding to and/or considering or dependent on the MPC or priority or target quality obtained. It may comprise and/or correspondingly comprise or be performed with any one or more of:

Selecting between two or more D2D measurement configurations, which may be pre-defined and/or pre-configured and/or stored in the D2D device or UE or a corresponding memory accessible to control circuitry of the D2D device or UE or an adapting module, and/or obtained based on a pre-defined rule or a condition, and/or received from another D2D device or UE or a network node, e.g. a controlling node, or a network, e.g. via broadcast/multicast or dedicated signalling, e.g. unicast or directed signalling, e.g. beam-formed signalling covering the D2D device or UE;
Adaptively configuring the number of samples of the measured signal or the signal to be measured;
(De)prioritizing a first D2D measurement type with respect to a second one (e.g., receiving all or at least N signals necessary for the first measurement type and performing the second measurement type with the remaining efforts or in a best effort);
(De)prioritizing a D2D measurement with respect to a cellular operation (e.g., receiving signals necessary to meet requirements for cellular operation always or in some subframes; receiving the D2D measured signals instead of performing a cellular operation in other subframes accepting some performance degradation/impact on the cellular operation);
Selecting time—(e.g., slot, subframe, time-domain pattern, time resource periodicity, etc.) and/or frequency resources (e.g., resource blocks, subbands, carrier frequency, frequency band, etc.) or scheduling the D2D measurements for the D2D device and/or UE;
Increase or decrease the D2D measurement periodicity for a lower or higher, respectively, target quality, and/or lower or higher, respectively, priority;
Increase or decrease the D2D measurement bandwidth for a higher or lower, respectively, target quality, and/or higher or lower, respectively, priority;
Increase or decrease the D2D measurement time for a higher or lower, respectively, target quality, and/or higher or lower, respectively, priority;
Reconfiguring non-D2D measurements or operations to match the obtained priority/target quality for D2D;
Scheduling non-D2D data or control information for the D2D device to match the obtained priority/target quality for D2D, e.g., avoiding scheduling cellular operations in subframes where the UE should prioritize D2D measurements (to reduce the impact on the cellular operation);
Configuring the activity or operation of the D2D device or UE (e.g. cellular DRX) adaptively to the obtained priority/target quality (e.g., the D2D device or UE may be configured to be cellular-active in the subframes prioritized for cellular operation and to be D2D-active in the subframes prioritized for D2D operation).

Using of the D2D measurement result and/or operating based on the measurement result may comprise any one or more of:

Signalling of the measurement result/measurement reporting to another d2D device or a network node (e.g., eNodeB or controlling node) or network or ProSe server. Signalling/measurement reporting may comprise signalling of a quality metric associated with the measurement result (e.g., number of samples, measurement error, a statistical characteristics such as standard deviation, signal quality of the measured signal);
Signalling the MPC or priority and/or target quality obtained to another D2D device or UE node or a network node (e.g., eNodeB or controlling node) or network or ProSe/D2D server, e.g. in case this information was not originating from this node or D2D device or network;
Using the measurement result for positioning purpose, e.g., D2D device or UE location calculation;
Using the measurement result for MDT purpose;
Using the measurement result for RRM purpose;
Using the measurement result for D2D device or UE synchronization or time alignment;
Using the measurement result for a radio link monitoring;
Using the measurement result for D2D channel decoding;
Using the measurement result for D2D channel quality estimation;
Using the measurement result for D2D channel feedback.

The signalling may generally be performed via D2D communication and/or via cellular communication, if the D2D device is connected or connectable to a cellular network and/or for cellular communication.

A network, or network node such as a controlling node, or a first D2D device, any of which may be connected or connectable for communication with a D2D device may perform and/or be adapted to perform:

Step 1: Determining or obtaining for the D2D device (which may be a second D2D device in particular in the case of the step being performed by a first D2D device) a measurement performance characteristic, e.g. at least one of a D2D measurement priority and D2D measurement target quality. There may be provided a corresponding obtaining or determining module as described herein.

Step 2: May comprise Step 2a and/or Step 2b and/or Step 2c described below.

Step 2a: Signalling/transmitting to the D2D device (which may be the second D2D device mentioned above) the determined or obtained MPC. e.g. at least one of D2D measurement priority and D2D measurement target quality, and/or

Signalling an indication or a trigger to the D2D device (which may be the second D2D device mentioned above) to change the MPC and/or D2D measurement configuration and/or priority and/or target quality, in particular change in a certain direction e.g. in an incremental manner (see also methods in the UE).

Step 2b: Signalling to a radio node (e.g. eNodeB or controlling node) or a network serving the D2D device (which may be the second D2D device mentioned above) the determined or obtained MPC, e.g. at least one of D2D measurement priority and UE D2D measurement target quality, or

Signalling an indication or a trigger to change for the D2D device (which may be the second D2D device mentioned above) the MPC or D2D measurement configuration and/or priority and/or target quality, in particular change in a certain direction e.g. in an incremental manner (see also methods in the UE).

Step 2c: configuring at least one D2D measurement for the first UE, based on the obtained priority/target quality.

Steps 2a, 2b and 2c and/or the corresponding signalling to the D2D device may be seen as, and/or be implemented as or part of, configuring the D2D device (which may be the second D2D device mentioned above). There may be provided a corresponding configuring module as described herein.

Step 3 (Optional): Receiving, from the D2D device, a D2D measurement result and/or measurement reporting and further optionally using it for at least one operational task, e.g. for configuring the first D2D device or the D2D device (which may be the second D2D device mentioned above) and/or scheduling resources, in particular communication resources, for at least one D2D device as described herein. There may be provided a corresponding receiving module and/or operating module and/or configuring module and/or scheduling module as described herein.

The node or network or first D2D device may comprise control circuitry and/or radio circuitry adapted for carrying out or performing the steps or actions described.

The determining or obtaining of MPC or priority or target quality (which in the following may refers or pertain specifically to measurements of the D2D device configured for measurement, i.e. the D2D device, which may be the second D2D device mentioned above) may be based on or comprise and/or consider any one or more of the criteria identified above and/or the following:

Receiving the MPC priority/target quality information from an application, another network node, e.g. a controlling node, a network, a D2D device, or from an external client;
Carrier frequency/frequency band type (e.g., Public Safety or Emergency); User demand or need (e.g., emergency or non-emergency);
Resource availability for D2D and/or cellular communication or operation (e.g., scarce resources may need to be used more efficiently);
D2D measurement periodicity (with longer periodicity it is more crucial to utilize each measurement opportunity);
D2D measurement type (e.g., received signal strength or quality, timing measurement, etc.),
D2D measurement purpose;
Number of D2D measurements (if the same measurement will be repeated shortly, the accuracy may be less crucial; multiple parallel measurements may be more challenging to perform with high quality);
Amount of processing efforts for one D2D measurement;
D2D service type using the D2D measurement (e.g., a commercial application which may be streaming or background [less crucial for background applications which are typically best-effort], and both may be less important compared to an emergency service);
The D2D measurement criticality;
D2D device power consumption for performing one D2D measurement and/or the measurements;
Priority and/or target quality for the D2D device (which may be the second D2D device mentioned above) received from the first D2D device, from another D2D device, from a network node (e.g. a controlling node), a network, or from a D2D server;
Estimated, predicted or measured interference level when performing the D2D measurement;
Estimated or predicted quality of the D2D measurement (e.g., absolute or relative);
Activity state of the D2D device (e.g., idle or active; in DRX or non-DRX).

The determining or obtaining may further comprise selecting a priority and/or target quality from a set of pre-defined or pre-configured values. In one example, the pre-configured values may be tabulated and selected from the table based on a condition. Such values may stored in a memory accessible for a corresponding control circuitry.

Configuring at least one D2D measurement for the D2D device and/or configuring the D2D measurement or adapting the D2D measurement configuration based on the obtained or determined MPC, e.g. priority and/or target quality, may further comprise any one or more of:

Selecting time—(e.g., slot, subframe, time-domain pattern, time resource periodicity, etc.) and/or frequency resources (e.g., resource blocks, subbands, carrier frequency, frequency band, etc.) or scheduling the D2D measurements for the D2D device;
Increase or decrease the D2D measurement periodicity for a lower or higher, respectively, target quality, and/or lower or higher, respectively, priority;
Increase or decrease the D2D measurement bandwidth for a higher or lower, respectively, target quality, and/or higher or lower, respectively, priority;
Increase or decrease the D2D measurement time for a higher or lower, respectively, target quality, and/or higher or lower, respectively, priority;
Reconfiguring non-D2D measurements or operations to match the obtained priority/target quality for D2D communication or operation;
Scheduling non-D2D data or control information for the D2D device to match the obtained priority/target quality for D2D, e.g., avoiding scheduling cellular operations in subframes where the UE should prioritize D2D measurements (to reduce the impact on the cellular operation);
Configuring the activity of the D2D device (e.g. cellular DRX) adaptively to the obtained MPC priority/target quality (e.g., the D2D device may be configured to be cellular-active in the subframes prioritized for cellular operation and to be D2D-active in the subframes prioritized for D2D operation)

Using the received D2D measurement result and/or the measurement reporting may comprise, e.g., any one or more of:

Signalling of the received measurement result to another D2D device or a network or a network node like a controlling node;
Signalling may additionally or alternatively comprise signalling of a quality metric associated with the measurement result (e.g., number of samples, measurement error, a statistical characteristics such as standard deviation, signal quality of the measured signal);
Storing in a database for a later use;
Storing in a history information; Using the measurement result for positioning purpose, e.g., the location calculation for the D2D device (which may be the second D2D device mentioned above);
Using the measurement result for calculating a performance metric or performance statistics for the D2D device (which may be the second D2D device mentioned above) and/or multiple D2D devices;
Using the measurement result for SON purpose;
Using the measurement result for MDT purpose;
Using the measurement result for RRM purpose;
Using the measurement result for synchronization or time alignment of a D2D device, in particular the D2D device (which may be the second D2D device mentioned above);
Using the measurement result for a radio link monitoring;
Using the measurement result for D2D channel decoding;
Using the measurement result for D2D channel quality estimation;
Using the measurement result for D2D channel feedback.

Generally, the criteria and conditions or uses may be the same analogous to those disclosed above,

In the context of this description, wireless communication may be communication, in particular transmission and/or reception of data, via electromagnetic waves and/or an air interface, in particular radio waves, e.g. in a wireless communication network and/or utilizing a radio access technology (RAT). The communication may be between nodes of a wireless communication network and/or in a wireless communication network. It may be envisioned that a node in or for communication, and/or in, of or for a wireless communication network is adapted for, and/or for communication utilizing, one or more RATs, in particular LTE/E-UTRA. A communication may generally involve transmitting and/or receiving messages, in particular in the form of packet data. A message or packet may comprise control and/or configuration data and/or payload data and/or represent and/or comprise a batch of physical layer transmissions. Control and/or configuration data may refer to data pertaining to the process of communication and/or nodes of the communication. It may, e.g., include address data referring to a node of the communication and/or data pertaining to the transmission mode and/or spectral configuration and/or frequency and/or coding and/or timing and/or bandwidth as data pertaining to the process of communication or transmission, e.g. in a header. Each node involved in such communication may comprise radio circuitry and/or control circuitry and/or antenna circuitry, which may be arranged to utilize and/or implement one or more than one radio access technologies. Radio circuitry of a node may generally be adapted for the transmission and/or reception of radio waves, and in particular may comprise a corresponding transmitter and/or receiver and/or transceiver, which may be connected or connectable to antenna circuitry and/or control circuitry. Control circuitry of a node may comprise a controller and/or memory arranged to be accessible for the controller for read and/or write access. The controller may be arranged to control the communication and/or the radio circuitry and/or provide additional services. Circuitry of a node, in particular control circuitry, e.g. a controller, may be programmed to provide the functionality described herein. A corresponding program code may be stored in an associated memory and/or storage medium and/or be hardwired and/or provided as firmware and/or software and/or in hardware. A controller may generally comprise a processor and/or microprocessor and/or microcontroller and/or FPGA (Field-Programmable Gate Array) device and/or ASIC (Application Specific Integrated Circuit) device. More specifically, it may be considered that control circuitry comprises and/or may be connected or connectable to memory, which may be adapted to be accessible for reading and/or writing by the controller and/or control circuitry. Radio access technology may generally comprise, e.g., Bluetooth and/or Wifi and/or WIMAX and/or cdma2000 and/or GERAN and/or UTRAN and/or in particular E-Utran and/or LTE. A communication may in particular comprise a physical layer (PHY) transmission and/or reception, onto which logical channels and/or logical transmission and/or receptions may be imprinted or layered. A node of a wireless communication network may be implemented as a D2D device and/or user equipment and/or base station and/or relay node and/or any device generally adapted for device-to-device communication. A wireless communication network may comprise at least one of a device configured for device-to-device communication, a D2D device, and/or a user equipment and/or base station and/or relay node, in particular at least one user equipment, which may be arranged for device-to-device communication with a second D2D device or node of the wireless communication network, in particular with a second user equipment. A node of or for a wireless communication network may generally be a wireless device configured for wireless device-to-device communication, in particular using the frequency spectrum of a cellular and/or wireless communications network, and/or frequency and/or time resources of such a network. Device-to-device communication may optionally include broadcast and/or multicast communication to a plurality of devices or nodes. A cellular network may comprise a network node, in particular a radio network node, which may be connected or connectable to a core network, e.g. a core network with an evolved network core, e.g. according to LTE. The connection between the network node and the core network/network core may be at least partly based on a cable/landline connection.

Operation and/or communication and/or exchange of signals involving part of the core network, in particular layers above a base station or eNB, and/or via a predefined cell structure provided by a base station or eNB, may be considered to be of cellular nature or be called cellular operation. Operation and/or communication and/or exchange of signals without involvement of layers above a base station and/or without utilizing a predefined cell structure provided by a base station or eNB, may be considered to be D2D communication or operation, in particular, if it utilises the radio resources, in particular carriers and/or frequencies, and/or equipment (e.g. circuitry like radio circuitry and/or antenna circuitry, in particular transmitter and/or receiver and/or transceiver) provided and/or used for cellular operation.

A user equipment (UE) may generally be a device configured for wireless device-to-device communication (it may be a D2D device) and/or a terminal for a wireless and/or cellular network, in particular a mobile terminal, for example a mobile phone, smart phone, tablet, PDA, etc. A user equipment may be a node of or for a wireless communication network as described herein, in particular a D2D device. It may be envisioned that a user equipment or D2D device is adapted for one or more RATs, in particular LTE/E-UTRA. A user equipment or D2D device may generally be proximity services (ProSe) enabled, which may mean it is D2D capable or enabled. It may be considered that a user equipment or D2D device comprises radio circuitry and/control circuitry for wireless communication. Radio circuitry may comprise for example a receiver device and/or transmitter device and/or transceiver device. Control circuitry may include a controller, which may comprise a microprocessor and/or microcontroller and/or FPGA (Field-Programmable Gate Array) device and/or ASIC (Application Specific Integrated Circuit) device. It may be considered that control circuitry comprises or may be connected or connectable to memory, which may be adapted to be accessible for reading and/or writing by the controller and/or control circuitry. A node or device of or for a wireless communication network, in particular a node or device for device-to-device communication, may generally be a user equipment or D2D device. It may be considered that a user equipment is configured to be a user equipment adapted for LTE/E-UTRAN.

A base station may be any kind of base station of a wireless and/or cellular network adapted to serve one or more user equipments. It may be considered that a base station is a node of a wireless communication network. A base station may be adapted to provide and/or define one or more cells of the network and/or to allocate or schedule frequency and/or time resources for communication to one or more nodes of a network, in particular UL resources, for example for device-to-device communication, which may be communication between devices different from the base station. Generally, any node adapted to provide such functionality may be considered a base station. It may be considered that a base station or more generally a network node, in particular a radio network node, comprises radio circuitry and/or control circuitry for wireless communication. It may be envisioned that a base station or network node is adapted for one or more RATs, in particular LTE/E-UTRA. Radio circuitry may comprise for example a receiver device and/or transmitter device and/or transceiver device. Control circuitry may include a controller, which may comprise a microprocessor and/or microcontroller and/or FPGA (Field-Programmable Gate Array) device and/or ASIC (Application Specific Integrated Circuit) device. It may be considered that control circuitry comprises or may be connected or connectable to memory, which may be adapted to be accessible for reading and/or writing by the controller and/or control circuitry. A base station may be arranged to be a node of a wireless communication network, in particular configured for and/or to enable and/or to facilitate and/or to participate in device-to-device communication, e.g. as a device directly involved or as an auxiliary and/or coordinating node. Generally, a base station may be arranged to communicate with a core network and/or to provide services and/or control to one or more user equipments and/or to relay and/or transport communications and/or data between one or more user equipments and a core network and/or another base station and/or be Proximity Service enabled. An eNodeB (eNB) may be envisioned as an example of a base station, in particular according to LTE. A base station may generally be proximity service enabled and/or to provide corresponding services. It may be considered that a base station is configured as or connected or connectable to an Evolved Packet Core (EPC) and/or to provide and/or connect to corresponding functionality. The functionality and/or multiple different functions of a base station may be distributed over one or more different devices and/or physical locations and/or nodes. A base station may be considered to be a node of a wireless communication network. Generally, a base station may be considered to be configured to be a controlling node and/or to allocate resources in particular for device-to-device communication between two nodes of a wireless communication network, in particular two user equipments.

Device-to-device (D2D) communication or operation may generally refer to communication between nodes or D2D devices of or for a wireless communication network or corresponding operation of one or more nodes, which may utilize the frequency spectrum and/or frequency and/or time resources of the network, in particular according to LTE/E-UTRAN. The communication may be wireless communication. A device in this context may be a node of the wireless communication network, in particular a user equipment or a base station. Device-to-device communication may in particular be communication involving at least one user equipment, e.g. between two or more user equipments. Device-to-device communication may be relayed and/or provided via a base station or coordinating node or relay node, in particular without interaction with a core network and/or layers of the network above a base station or coordinating node, or be direct communication between two devices, e.g. user equipments, without involvement of a base station or controlling node and/or with a base station or controlling node providing merely auxiliary services, e.g. configuration data or a transmission configuration or related information for a message intended for device-to-device communication between user equipments. D2D communication may be communication between two D2D devices in a region without cellular coverage and/or without interaction with a cellular or mobile network. In the latter case, it may be considered that data and/or signals flowing between the nodes performing device-to-device communication are not transported via a base station and/or controlling node. In contrast, during cellular communication, network layers above the eNB/base station/coordination node may generally be involved, in particular core layers which may be connected to the eNB/base station/coordinating node via cable/land line. During device-to-device communication, a message may be provided and/or transmitted and/or received. A message may be considered to be or be represented by a batch of physical layer transmissions and/or may comprise such. A message may comprise information regarding the transmission configuration, in particular regarding related information, e.g. in a header, and/or a payload. A unidirectional message may be a message for connectionless communication and/or for which no prior communication and/or prior connection between the transmitting node and receiving node is necessary and/or available and/or for which no response or no response protocol or no handshake is expected. A device configured for and/or capable of device-to-device communication, which may be called D2D device or D2D enabled node, may comprise control circuitry and/or radio circuitry configured to provide device-to-device communication, in particular configured to enable proximity services (ProSe-enabled), e.g., according to LTE/E-UTRA requirements. D2D operation or communication and cellular operation or communication may be considered different operation types or modes, which may generally performed using resources from the same pool of available resources, e.g. allocated resources and/or the same carriers.

A storage medium may be adapted to store data and/or store instructions executable by control circuitry and/or a computing device, the instruction causing the control circuitry and/or computing device to carry out and/or control any one of the methods described herein when executed by the control circuitry and/or computing device. A storage medium may generally be computer-readable, e.g. an optical disc and/or magnetic memory and/or a volatile or non-volatile memory and/or flash memory and/or RAM and/or ROM and/or EPROM and/or EEPROM and/or buffer memory and/or cache memory and/or a database.

Resources or communication resources may generally be frequency and/or time resources. Allocated or scheduled resources may comprise and/or refer to frequency-related information, in particular regarding one or more carriers and/or bandwidth and/or subcarriers and/or time-related information, in particular regarding frames and/or slots and/or subframes, and/or regarding resource blocks and/or time/frequency hopping information. Allocated resources may in particular refer to UL resources, e.g. UL resources for a first D2D device to transmit to and/or for a second D2D device. Transmitting on allocated resources and/or utilizing allocated resources may comprise transmitting data on the resources allocated, e.g. on the frequency and/or subcarrier and/or carrier and/or timeslots or subframes indicated. It may generally be considered that allocated resources may be released and/or de-allocated. A network or a node of a network, e.g. an allocation node, may be adapted to determine and/or transmit corresponding allocation data indicating release or de-allocation of resources to one or more D2D devices, in particular to a first D2D device. Accordingly, D2D resource allocation may be performed by the network and/or by a node, in particular a node within and/or within a cell of a cellular network covering the D2D devices participating or intending to participate in the D2D communication.

Allocation data may be considered to be data indicating and/or granting resources allocated by the allocation node, in particular data identifying or indicating which resources are reserved or allocated for D2D communication for a D2D device and/or which resources a D2D device may use for D2D communication and/or data indicating a resource grant or release. A grant or resource grant may be considered to be one example of allocation data. It may be considered that an allocation node is adapted to transmit allocation data directly to a node and/or indirectly, e.g. via a relay node and/or another node or base station. Allocation data may comprise control data and/or be part of or form a message, in particular according to a pre-defined format, for example a DCI format, which may be defined in a standard, e.g. LTE. In particular, allocation data may comprise information and/or instructions to reserve resources or to release resources, which may already be allocated. Generally, allocation data may indicate and/or instruct transmission mode and/or configuration, in particular regarding a power level of transmission, e.g. for the first D2D device. The first D2D device may generally be adapted to perform transmission configuration according to allocation data, in particular to set a corresponding power level. It may be considered that allocation data comprises and/or is implemented as TPC and/or in TPC format.

A D2D transmission may be considered to be of a different type than a cellular and/or UL transmission. A transmission may pertain to a specific frequency and/or spectrum and/or bandwidth and/or carrier.

A receiver or receiver chain may generally be provided by a transceiver arrangement, which may have transmitting capabilities included, or as a separate arrangement, which may be implemented without having transmitting capacities included.

A measurement gap may refer to a time gap or interval, in which no transmission and reception happens, in particular regarding a serving cell or a given carrier. Since there is no signal transmission and reception during the gap (at least in the serving cell or given carrier), a D2D device or UE can switch to another or a target cell or carrier and/or perform a measurement on the target cell or carrier, e.g. for signal quality, utilizing the same receiver.

The term “intra-frequency” may refer to issued related to the same frequency/bandwith and/or carrier, e.g. between neighboring cells (which may be provided by different BSs) having the same frequencies available. The term “inter-frequency” may refer to issues related to different frequencies/bandwidths and/or carriers, e.g. between different carriers in a multi-carrier arrangement.

A receiving operation may comprise a measurement operation, e.g. a signal quality measurement, which may be performed in a measurement gap, in which a receiver switching to a carrier/frequency to be measured may be performed.

In the context of this description, a D2D device generally may be a device capable of D2D communication and/or operation, in particular using frequencies and/or resources of a cellular and/or licensed communication system, e.g. a system according to a LTE standard, and may be also referred to as D2D enabled or capable UE or node. A D2D device may comprise any entity or equipment or device or node capable of at least receiving and/or transmitting radio signals on a direct radio link, i.e., between the entity and another D2D capable entity or D2D device. A D2D device or D2D device may for example be comprised in or comprise a cellular UE, PDA, a wireless device, laptop, mobile, sensor, relay, D2D relay, a small base station employing a UE-like interface, etc. Any device or entity capable to support and/or perform at least one D2D operation may be considered a D2D device; a D2D device may be adapted to support and/or perform at least one D2D operation. A D2D device may generally be adapted for cellular operation and/or communication in a wireless communication network. It may be considered that a D2D device generally comprises radio circuitry and/or control circuitry for wireless communication, in particular D2D operation or communication and cellular operation or communication. A D2D device may comprise a software/program arrangement arranged to be executable by a hardware device, e.g. control circuitry, and/or storable in a memory of e.g. a UE or terminal, which may provide D2D functionality and/or corresponding control functionality to e.g. a UE or terminal.

D2D operation may comprise any action or activity related to D2D or D2D communication and may be used interchangeably with D2D communication. D2D operation may include, e.g., transmitting or receiving a signal/channel type or data for D2D purposes and/or in D2D operation, transmitting or receiving data by means of D2D communication, transmitting or receiving control or assistance data for D2D purpose, transmitting or receiving a request for control or assistance data for D2D, selecting a D2D operation mode, initiating/starting D2D operation, switching to D2D operation mode from a cellular operation mode, configuring receiver or transmitter with one or more parameters for D2D. D2D operation may be for a commercial purpose or to support public safety, using the data related to D2D. D2D operation may or may not be specific to a certain D2D service. A D2D receive operation may be, and/or be comprised in, a D2D operation, which may, in one example, also involve other than D2D receive operations. A D2D operation may generally be performed or performable by a D2D device or UE. A D2D receive operation may comprise receiving, by a D2D device, of D2D data and/or signals. A D2D transmit operation may comprise, transmitting, by a D2D device, of D2D data and/or signals. A D2D device performing at least one D2D operation may be considered to be in D2D or D2D mode or in D2D operation. D2D operation may comprise D2D measurements.

A D2D measurement may be a measurement, e.g. performed by a D2D device, performed for D2D purpose and/or on D2D signals/channels and/or regarding D2D operation and/or communication. D2D measurement may comprise any one or any combination of: D2D RRM measurement, D2D positioning measurement, D2D synchronization measurement, measurement on D2D synchronization signals, measurement on D2D reference signals, measurement on D2D channel/s, signal-to-noise measurement, signal strength measurement, signal quality measurement, in particular measurement of received signal strength, of received signal quality, RLM, synchronization, one-directional and/or two-directional timing measurement, RTT or Rx-Tx or similar measurement, measurement of number of successful and/or unsuccessful channel decodings or receptions, data throughput measurements, measurement of amount of data transmitted and/or received, billing-relevant measurement; these measurement may be performed regarding D2D communication and/or D2D operation.

Cellular operation (in particular by a D2D device or UE) may comprise any action or activity related to a cellular network (any one or more RATs). Some examples of cellular operation may be a radio signal transmission, a radio signal reception, performing a radio measurement, performing a mobility operation or RRM related to a cellular network.

D2D transmission or communication may be any transmission or communication by a D2D device or device and/or in a D2D operation or mode or communication. Some examples of D2D transmission may comprise physical signals or physical channels, dedicated or common/shared, e.g., reference signal, synchronization signal, discovery channel, control channel, data channel, broadcast channel, paging channel, scheduling assignment (SA) transmissions, etc. A D2D transmission on a direct radio link may be intended for receiving by another D2D device. A D2D transmission may be a unicast, groupcast, or broadcast transmission. A D2D transmission may be on the uplink time-frequency resources of a wireless communication system.

A controlling node may generally be a network node connected or connectable to a D2D device for cellular and/or D2D communication. A controlling node may be defined by its functionality of providing and/or transmitting a measurement performance characteristic to a D2D device and/or of configuring the D2D device, in particular based on the measurement performance characteristic. A controlling node may be a network node that is adapted to schedule, decide and/or select and/or allocate, at least in part, time-frequency resources to be used for at least one of: cellular communication or transmissions and D2D communication or transmissions. The controlling node may also provide scheduling information and/or measurement performance characteristic to another node, such as another D2D device, a cluster head, a radio network node such as eNodeB, or a network node (e.g. a core network node), MME, positioning node, D2D server, RNC, SON, etc). The network node or controlling node may communicate with a radio network node. It may be envisioned that a controlling node may also perform coordination and/or control for one or more D2D device or UEs. The coordination and/or control may be performed in a centralized or distributed manner. A controlling node may be referred to as an allocating node and/or a coordinating node.

A network device or node and/or a D2D device may be or comprise a software/program arrangement arranged to be executable by a hardware device, e.g. control circuitry, and/or storable in a memory, which may provide D2D functionality and/or corresponding control functionality.

Radio spectrum: Although at least some of the embodiments may be described for D2D transmissions in the UL spectrum (FDD) or UL resources (TDD), the embodiments are not limited to the usage of UL radio resources, neither to licensed or unlicensed spectrum, or any specific spectrum at all.

A cellular network or mobile or wireless communication network may comprise e.g. an LTE network (FDD or TDD), UTRA network, CDMA network, WiMAX, GSM network, any network employing any one or more radio access technologies (RATs) for cellular operation. The description herein is given for LTE, but it is not limited to the LTE RAT.

RAT (radio access technology) may generally include: e.g. LTE FDD, LTE TDD, GSM, CDMA, WCDMA, WiFi, WLAN, WiMAX, etc.

A network node may be a radio network node (which may be adapted for wireless or radio communication, e.g. with a D2D device or a UE) or another network node. A network node generally may be a controlling node. Some examples of a radio network node or controlling node are a radio base station, in particular an eNodeB, a relay node, an access point, a cluster head, RNC, etc. The radio network node may be comprised in a mobile communication network and may support and/or be adapted for cellular operation or communication and/or D2D operation or communication. A network node, in particular a radio network node, may comprise radio circuitry and/or control circuitry, in particular for wireless communication. Some examples of a network node, which is not a radio network node, may comprise: a core network node, MME, a node controlling at least in part mobility of a wireless device, SON node, O&M node, positioning node, a server, an application server, a D2D server (which may be capable of some but not all D2D-related features), a node comprising a ProSe function, a ProSe server, an external node, or a node comprised in another network. Any network node may comprise control circuitry and/or a memory. A network node may be considered to be serving a D2D device or UE, if it provides a cell of a cellular network to the served node or D2D device or UE and/or is connected or connectable to the D2D device or UE via and/or for transmission and/or reception and/or UL and/or DL data exchange or transmission and/or if the network node is adapted to provide the D2D device or UE with allocation and/or configuration data and/or a measurement performance characteristic and/or to configure the D2D device or UE.

Multiple carrier frequencies or functionality may refer to any of: different carrier frequencies within the same frequency band or within different frequency bands, same PLMN or different PLMNs, same RAT or different RATs. D2D operation may or may not occur on dedicated carrier frequencies. DL and UL carrier frequencies in FDD are also examples of different carrier frequencies. A frequency band herein may be FDD, TDD, HD-FDD, or unidirectional (e.g., DL-only band such as Band 29, in some examples). Multiple carrier functionality may include carrier aggregation functionality, in which multiple carriers or cells are used for transmission and/or reception between two participants of communication. The carriers may be continuous in the spectrum or discontinuous.

The term ‘TPC for D2D’ used herein may refer to or comprise at least one power control command for one or more of D2D transmissions (e.g., SA, D2D data, D2D synchronization signal, D2D control channel, D2D discovery transmission, any D2D transmission for D2D communication, any D2D transmission for D2D discovery). ‘TPC for cellular UL’ may comprise or refer to at least one power control command sent by or via a network node or eNodeB to control tx power of one or more cellular UL transmissions. The two different types of TPCs may be sent in the same or separate messages to the D2D device or UE, via the same or different channels or channel types (e.g., PDCCH and/or EPDCCH) and/or be comprises in one set or packet or message of allocation data or in different sets or packets or messages of allocation data.

A D2D device may generally be a node or device adapted to perform D2D communication, in particular transmission and/or reception, and/or at least one type of D2D operations. In particular, a D2D device may be a terminal and/or user equipment and/or D2D enabled machine and/or sensor. The D2D device may be adapted to transmit and/or receive D2D data based on allocation data, in particular on and/or utilizing resources indicate in the allocation data. D2D communication and/or transmission by a D2D device may generally be in UL resources and/or corresponding carrier or frequency and/or modulation. A D2D device (such as a UE) may be adapted for and/or capable of CA or CA operation. In particular, it may be adapted to transmit and/or receive one or more than one CCs and/or utilising, and/or participating in, carrier aggregation. A D2D device may be adapted to configure itself and/or be configured according to configuration data, which may include setting up and/or scheduling resources and/or equipment for receiving and/or transmitting and/or sharing of resources and/or in particular D2D operation and/or cellular operation based on the configuration data. Configuration data may be received, by the D2D device, from another node or D2D device, in particular a network node. A network node, in particular a controlling and/or allocating node, may generally be adapted to provide and/or determine and/or transmit configuration data, in particular to a D2D device. Configuration data may be considered to be a form of allocation data and/or may be provided in the form of a message and/or data packet/s. Configuring a D2D device or UE, e.g. configuring of the node by a network node, may include determining and/or transmitting configuration data to the node to be configured, i.e. the D2D device or UE. Determining the configuration data and transmitting this data to a D2D device or UE may be performed by different nodes, which may be arranged such that they may communicate and/or transport the configuration data between each other, in particular such that the node determining or adapted to determine the configuration data may transmit the configuration data to the node transmitting it or adapted to transmit it; the latter node may be adapted to receive the configuration data and/or relay and/or provide a message bases on the configuration data, e.g. by reformatting and/or amending and/or updating data received.

Transmit power (or power density) may generally refer to the power (or power density) of a signal transmitted or generally to the power of wireless transmission. Transmit power (or power density) may in particular refer to the power (or power density) of a signal transmitted by and/or transmissions of a D2D device or UE. Transmit power generally may refer to a specific channel and/or frequency and/or cell and/or carrier and/or bandwidth and/or carrier aggregate and/or a general setup. UL transmit power, or shorter UL power, may refer to the power of a signal transmitted, in particular by a D2D device or UE, in cellular operation and/or to or for a network node serving the D2D device or UE, for example a base station or eNodeB. D2D transmit power (or power density) may refer to the power (or power density) of a signal transmitted, in particular by a D2D device or UE, in D2D operation and/or for D2D transmission. Transmit power (or power density) may refer to or pertain to a time unit or interval, e.g. a slot, subframe or frame, and/or transmit power control may be performed for and/or updated in such units or intervals. Power control or transmit power control may generally refer to control of transmit power and/or transmit power spectral and/or temporal density. Power control commands in TPC format or TPC may be used for controlling power and/or to cause a D2D device or UE receiving at least one such command or TPC message to control power based on and/or according to the command or TPC. The command or TPC may be transmitted to the D2D device from or via a network node, in particular a base station or eNB or allocating node.

Capability data and/or a capability indication or indication message may provide and/or comprise capability information. In this context, the capability may refer to whether the D2D device or UE is capable of operating simultaneously perform D2D and cellular operations on a combination of carriers and/or frequency bands and/or to which combination/s of carriers and/or frequency bands a D2D device or UE can be configured, and/or is operable in and/or adapted to operate in, to simultaneously perform D2D and cellular operations; or at least a part of the corresponding combinations. Capabilities information and/or the indication or indication message, may indicate explicitly or implicitly one, or at least one, or a plurality of, combination/s of carriers and/or frequency bands on which the first D2D device or UE can be configured and/or is operable in and/or adapted to operate in, to simultaneously perform D2D and cellular operations, and/or may comprise parameters and/or parameter values and/or indication and/or information regarding the capabilities of the first D2D device. The capability indication or indication message may be transmitted or transmittable as a D2D transmission or a cellular transmission. It may be envisioned that a D2D device or UE determines and/or transmits and/or is adapted to determine and/or transmit such a message either and/or both as a D2D transmission and as a cellular transmission. In particular, a D2D device or UE may transmit or be adapted to transmit the indication or indication message as D2D transmission, in particular based on the target of the transmission being, and/or if the target of the transmission is, a second D2D device or UE, and/or based on corresponding D2D resources being, and/or if corresponding D2D resources are, allocated to the D2D device or UE. Alternatively or additionally, the D2D device or UE may transmit, and/or be adapted to transmit, the indication or indication message in or with a cellular transmission or operation, in particular if the target node is not a D2D device and/or based on cellular or only cellular resources being allocated to the D2D device or UE. A D2D device may be adapted to obtain capabilities information, e.g. by reading it from a memory or storage, which may be a memory or storage of the D2D device or UE.

A D2D device may comprise an obtaining module for obtaining capabilities information, e.g. as described herein. Additionally or alternatively, a D2D device may comprise a capabilities information transmitting device for transmitting a capabilities indication or indication message as described herein.

Cellular DL operation and/or communication of a D2D device or UE may refer to receiving transmissions in DL, in particular in cellular operation and/or from a network node/eNB/base station. Cellular UL operation of a D2D device or UE may refer to UL transmissions, in particular in cellular operation, e.g. transmitting to a network node/eNB/base station.

Indicating an information and/or condition, in particular indicating by a first node to a second node, may comprise transmitting the information, a corresponding message and/or data and/or indication, in particular from the first node to the second node node, e.g. via a cellular transmission or a D2D transmission, or if the first node and second node are connected by cable, via cable.

Each or any one of the D2D devices or user equipments shown in the figures may be adapted to perform the methods to be carried out by a user equipment or D2D device described herein. Alternatively or additionally, each or any of the D2D devices or user equipments shown in the figures may comprise any one or any combination of the features of a user equipment or D2D device described herein. Each or any one of the network nodes or controlling nodes or eNBs or base stations shown in the figures may be adapted to perform the methods to be carried out by network node or base station described herein. Alternatively or additionally, the each or any one of the controlling or network nodes or eNBs or base stations shown in the figures may comprise any one or any one combination of the features of a network node or eNB or base station described herein.

Some abbreviations used are:
3GPP 3^{rd} Generation Partnership Project
Ack/Nack Acknowledgment/Non-Acknowledgement, also A/N
AP Access point
BER/BLER Bit Error Rate, BLock Error Rate;
BS Base Station
CA Carrier Aggregation
CoMP Coordinated Multiple Point Transmission and Reception
CQI Channel Quality Information
CRS Cell-specific Reference Signal
CSI Channel State Information
CSI-RS CSI reference signal
D2D Device-to-device
DL Downlink
EPDCCH Enhanced Physical DL Control CHannel
DL Downlink; generally referring to transmission of data to a node/into a direction further away from network core (physically and/or logically); in particular from a base station or eNodeB to a D2D device or UE; often uses specified spectrum/bandwidth different from UL (e.g. LTE)
eNB evolved NodeB; a form of base station, also called eNodeB
E-UTRA/N Evolved UMTS Terrestrial Radio Access/Network, an example of a RAT f1, f2, f3, . . . , fn carriers/carrier frequencies; different numbers may indicate that the referenced carriers/frequencies are different
f1_UL, . . . , fn_UL Carrier for Uplink/in Uplink frequency or band
f1_DL, . . . , fn_DL Carrier for Downlink/in Downlink frequency or band
FDD Frequency Division Duplexing
ID Identity
L1 Layer 1
L2 Layer 2
LTE Long Term Evolution, a telecommunications or wireless or mobile communication standard
MAC Medium Access Control
MBSFN Multiple Broadcast Single Frequency Network
MDT Minimisation of Drive Test
MPC Measurement Performance Characteristic
NW Network
OFDM Orthogonal Frequency Division Multiplexing
O&M Operational and Maintenance
OSS Operational Support Systems
PC Power Control
PDCCH Physical DL Control CHannel
PH Power Headroom
PHR Power Headroom Report
PSS Primary Synchronization Signal
PUSCH Physical Uplink Shared CHannel
RA Random Access
RACH Random Access CHannel
RAT Radio Access Technology
RE Resource Element
RB Resource Block
RRH Remote radio head
RRM Radio Resource Management
RRU Remote radio unit
RSRQ Reference signal received quality
RSRP Reference signal received power
RSSI Received signal strength indicator
RX reception/receiver, reception-related
SA Scheduling Assignment
SINR/SNR Signal-to-Noise-and-Interference Ratio; Signal-to-Noise Ratio
SFN Single Frequency Network
SON Self Organizing Network
SSS Secondary Synchronization Signal
TPC Transmit Power Control
TX transmission/transmitter, transmission-related
TDD Time Division Duplexing
UE User Equipment
UL Uplink; generally referring to transmission of data to a node/into a direction closer to a network core (physically and/or logically); in particular from a D2D device or UE to a base station or eNodeB; in the context of D2D, it may refer to the spectrum/bandwidth utilized for transmitting in D2D, which may be the same used for UL communication to a eNB in cellular communication; in some D2D variants, transmission by all devices involved in D2D communication may in some variants generally be in UL spectrum/bandwidth/carrier/frequency

These and other abbreviations may be used according to LTE standard definitions.

In this description, for purposes of explanation and not limitation, specific details are set forth (such as particular network functions, processes and signalling steps) in order to provide a thorough understanding of the technique presented herein. It will be apparent to one skilled in the art that the present concepts and aspects may be practiced in other embodiments and variants that depart from these specific details.

For example, the concepts and variants are partially described in the context of Long Term Evolution (LTE) or LTE-Advanced (LTE-A) mobile or wireless communications technologies; however, this does not rule out the use of the present concepts and aspects in connection with additional or alternative mobile communication technologies such as the Global System for Mobile Communications (GSM). While the following embodiments will partially be described with respect to certain Technical Specifications (TSs) of the Third Generation Partnership Project (3GPP), it will be appreciated that the present concepts and aspects could also be realized in connection with different Performance Management (PM) specifications.

Moreover, those skilled in the art will appreciate that the services, functions and steps explained herein may be implemented using software functioning in conjunction with a programmed microprocessor, or using an Application Specific Integrated Circuit (ASIC), a Digital Signal Processor (DSP), a Field Programmable Gate Array (FPGA) or general purpose computer. It will also be appreciated that while the embodiments described herein are elucidated in the context of methods and devices, the concepts and aspects presented herein may also be embodied in a program product as well as in a system comprising control circuitry, e.g. a computer processor and a memory coupled to the processor, wherein the memory is encoded with one or more programs or program products that execute the services, functions and steps disclosed herein.

It is believed that the advantages of the aspects and variants presented herein will be fully understood from the foregoing description, and it will be apparent that various changes may be made in the form, constructions and arrangement of the exemplary aspects thereof without departing from the scope of the concepts and aspects described herein or without sacrificing all of its advantageous effects. Because the aspects presented herein can be varied in many ways, it will be recognized that any scope of protection should be defined by the scope of the claims that follow without being limited by the description.

1. A method for operating a mobile communication network, the method comprising:
determining a measurement performance characteristic for a Device-to-Device (D2D) device in communication with the network; and
configuring the D2D device for D2D measurement with the measurement performance characteristic.

2. The method according to claim 1, further comprising receiving, from the D2D device, D2D measurement reporting based on the measurement performance characteristic.

3. The method according to claim 1, further comprising configuring the D2D device based on the received D2D measurement reporting.

4. A method for operating a Device-to-Device (D2D) device, comprising:
obtaining a measurement performance characteristic; and
performing D2D measurement according to the measurement performance characteristic.

5. The method according to claim 4, further comprising adapting a D2D measurement configuration of the D2D device based on the obtained measurement performance characteristic, wherein performing D2D measurement is based on the D2D measurement configuration.

6. The method according to claim 4, wherein obtaining a measurement performance characteristic comprises receiving a measurement performance characteristic from a network, in particular a cellular network and/or a controlling node.

7. The method according to claim 4, wherein obtaining a measurement performance characteristic comprises receiving at least one measurement performance characteristic from another D2D device.

8. A method for operating a controlling node of a mobile communication network, the method comprising:
obtaining, by the controlling node, a measurement performance characteristic for a Device-to-Device (D2D) device in D2D communication with the network; and
configuring, by the controlling node, the D2D device for D2D measurement with the measurement performance characteristic.

9. The method according to claim 8, further comprising receiving, by the controlling node, D2D measurement reporting based on the measurement performance characteristic from the D2D device.

10. A method for operating a first Device-to-Device (D2D) device, the method comprising:
obtaining, by the first D2D device, a measurement performance characteristic for a second D2D device connected or connectable to the first D2D device for D2D communication; and
configuring, by the first D2D device, the second D2D device for D2D measurement with the measurement performance characteristic.

11. The method according to claim 10, further comprising receiving, by the first D2D device, D2D measurement reporting based on the measurement performance characteristic from the second D2D device.

12. A mobile communication network, the network
being adapted for determining a measurement performance characteristic for a Device-to-Device (D2D) device connected or connectable for communication with the network; and
and further being adapted for configuring the D2D device for D2D measurement with the measurement performance characteristic.

13. The network according to claim 12, further being adapted for receiving, from the D2D device, D2D measurement reporting based on the measurement performance characteristic.

14. The network according to claim 12, the network being further adapted for configuring the D2D device based on the received D2D measurement reporting.

15. A Device-to-Device (D2D) device adapted for D2D communication, the D2 device
being adapted for obtaining a measurement performance characteristic; and
and further being adapted for performing D2D measurement according to the measurement performance characteristic.

16. The D2D device according to claim 15, further being adapted for adapting a D2D measurement configuration of the D2D device based on the obtained measurement performance characteristic, the D2D device further being adapted for performing D2D measurement based on the D2D measurement configuration.

17. The D2D device according to claim 15, wherein obtaining a measurement performance characteristic comprises receiving a measurement performance characteristic from a network, in particular a cellular network and/or a controlling node.

18. The D2D device according to claim 15, wherein obtaining a measurement performance characteristic comprises receiving at least one measurement performance characteristic from another D2D device.

19. A controlling node for a mobile communication network, the controlling node
being adapted for obtaining a measurement performance characteristic for a Device-to-Device (D2D) device connected or connectable for D2D communication with the network; and
the controlling node being further adapted for configuring the D2D device for D2D measurement with the measurement performance characteristic.

20. The controlling node according to claim 19, the controlling node further being adapted for receiving D2D measurement reporting based on the measurement performance characteristic from the D2D device.

21. A Device-to-Device (D2D) device adapted for D2D communication, the D2D device
being adapted for obtaining a measurement performance characteristic for a second D2D device connected or connectable for D2D communication with the D2D device; and
the D2D device being further adapted for configuring the second D2D device for D2D measurement with the measurement performance characteristic.

22. The D2D device according to claim 21, the D2D device further being adapted for receiving D2D measurement reporting based on the measurement performance characteristic from the D2D device.

23. (canceled)

24. (canceled)
